(19) United States
(12) Patent Application Publication
(10) Pub. No.: US 2013/0055038 A1
(43) Pub. Date: Feb. 28, 2013

(54) COMPUTING UNIT ABNORMALITY DETERMINING APPARATUS AND METHOD

(71) Applicants: Munenori Nakamura, Toyota-shi (JP); Yuko Kariya, Toyota-shi (JP)

(72) Inventors: Munenori Nakamura, Toyota-shi (JP); Yuko Kariya, Toyota-shi (JP)

(73) Assignee: TOYOTA JIDOSHA KABUSHIKI KAISHA, Toyota-shi, Aichi (JP)

(21) Appl. No.: 13/697,240

(22) PCT Filed: May 12, 2010
(86) PCT No.: PCT/JP2010/058069

§ 371 Date: Nov. 9, 2012

(51) Int. Cl. G06F 11/08

(52) U.S. Cl. 714/48; 714/E11.031

(57) ABSTRACT

According to the present invention, a computing unit abnormality determining apparatus is disclosed which determines whether there is an abnormality in a computing unit, comprising a comparison operation abnormality determining part configured to perform a comparison operation using the computing unit to determine whether there is an abnormality in the comparison operation; and an arithmetic/logical operation abnormality determining part configured to perform an arithmetic/logical operation of a predetermined operational expression using the computing unit, the predetermined operational expression including at least one of an arithmetic operation and a logical operation, and compare an operational result obtained by the arithmetic/logical operation with a corresponding stored value of a correct value to determine whether there is an abnormality in the arithmetic/logical operation.

### TECHNICAL FIELD

The present invention is related to a computing unit abnormality determining apparatus and a computing unit abnormality determining method of determining whether there is an abnormality in a computing unit.

### BACKGROUND ART

An arithmetic unit is known which makes a calculating unit calculate a predetermined arithmetic problem at a predetermined monitoring cycle and acquires the calculation results of the calculating unit, and determines whether the arithmetic processing is normally performed by comparing the calculation result with an answer set in advance with respect to the arithmetic problem (see Patent Document 1, for example). Further, Patent Document 1 discloses a configuration in which a single microcomputer performs an arithmetic monitoring routine in addition to a main control routine and a run-pulse generating routine. According to the configuration, the microcomputer performs the arithmetic monitoring process to perform self-determination whether the arithmetic processing for the controlling processes of the main control process is normally performed, and suspends the execution of the main control process based on the determination result.

[Patent Document 1] Japanese Patent No. 4003420 (FIG. 7(b))

### DISCLOSURE OF INVENTION

### Problem to be Solved by Invention

According to the configuration disclosed in Patent Document 1, it is necessary to perform the comparison operation when the calculation result is compared with an answer set in advance with respect to the arithmetic problem. However, if the comparison operation is not normally performed, an erroneous determination result may be output.

Therefore, an object of the present invention is to provide a computing unit abnormality determining apparatus and a computing unit abnormality determining method which can determine with high accuracy whether there is an abnormality in a computing unit by determining whether there is an abnormality in a comparison operation.

### Means to Solve the Problem

In order to achieve the object described above, according to an aspect of the present invention, a computing unit abnormality determining apparatus is provided which determines whether there is an abnormality in a computing unit. The computing unit abnormality determining apparatus includes:

a comparison operation abnormality determining part configured to perform a comparison operation using the computing unit to determine whether there is an abnormality in the comparison operation; and

an arithmetic/logical operation abnormality determining part configured to perform an arithmetic/logical operation of a predetermined operational expression using the computing unit, the predetermined operational expression including at least one of an arithmetic operation and a logical operation, and compare an operational result obtained by the arithmetic/logical operation with a corresponding stored value of a correct value to determine whether there is an abnormality in the arithmetic/logical operation.

According to an aspect of the present invention, a computing unit abnormality determining method of determining whether there is an abnormality in a computing unit is provided. The computing unit abnormality determining apparatus includes:

performing a comparison operation using the computing unit to determine whether there is an abnormality in the comparison operation; and

performing an arithmetic/logical operation of a predetermined operational expression using the computing unit, the predetermined operational expression including at least one of an arithmetic operation and a logical operation, and comparing an operational result obtained by the arithmetic/logical operation with a corresponding stored value of a correct value to determine whether there is an abnormality in the arithmetic/logical operation.

### Advantage of the Invention

According to the present invention is to provide a computing unit abnormality determining apparatus and a computing unit abnormality determining method can be obtained which can determine with high accuracy whether there is an abnormality in a computing unit by determining whether there is an abnormality in a comparison operation.

### BRIEF DESCRIPTION OF DRAWINGS

FIG. 1 is a diagram for illustrating an example of a main configuration of an electronic arithmetic unit 10 which includes a computing unit abnormality determining apparatus according to an embodiment of the present invention.

FIG. 2 is a timing chart of an example of an abnormality detecting process of the electronic arithmetic unit 10.

FIG. 3 is a diagram for illustrating a main function of a computing unit abnormality determining apparatus 40 according to one embodiment of the present invention.

FIG. 4 is a diagram for illustrating an example of a monitoring process program.

FIG. 5 is a diagram for illustrating a breakdown of a operational expression.

FIG. 6 is an example of a flowchart of a monitoring process executed by the computing unit abnormality determining apparatus 40.

### DESCRIPTION OF REFERENCE SYMBOLS

10 electronic arithmetic unit
20 microcomputer

021 CPU
22 ALU
24 PSU
26 BSF
28 port
30 power supply IC
32 watchdog timer
34 abnormality detecting part
36 reset part
40 computing unit abnormality determining apparatus
42 comparison operation abnormality determining part
44 arithmetic/logical operation abnormality determining part

### BEST MODE FOR CARRYING OUT THE INVENTION

In the following, the best mode for carrying out the present invention will be described in detail by referring to the accompanying drawings.

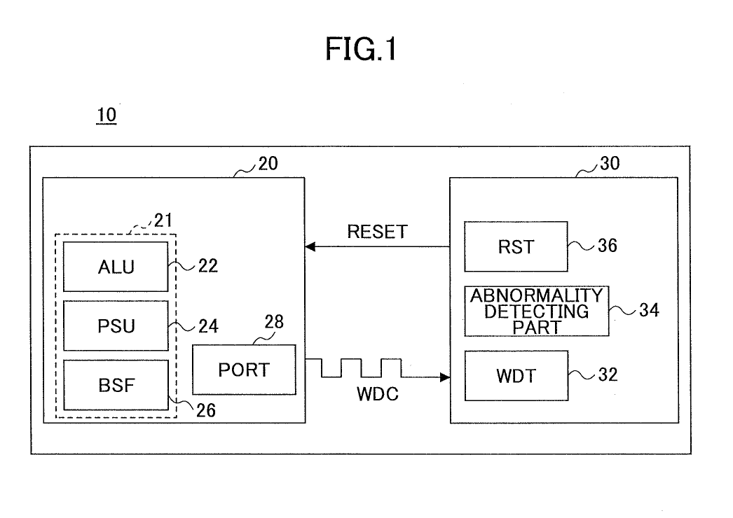

FIG. 1 is a diagram for illustrating an example of a main configuration of an electronic arithmetic unit 10 which includes a computing unit abnormality determining apparatus 1 according to an embodiment of the present invention.

The electronic arithmetic unit 10 includes a microcomputer 20 and a power supply IC 30, as illustrated in FIG. 1.

The microcomputer 20 includes a CPU (Central Processing Unit) 21. The CPU 21 includes an ALU (Arithmetic and Logic Unit) 22 which performs arithmetic and logical operations, a PSU (Program Status Unit) 24, a BSF (Barrel Shifter) 26 which performs a shifting operation, etc. Further, the microcomputer 20 includes a port 28 for outputting a watchdog cancel signal (WDC) to the power supply IC 30.

The power supply IC 30 is provided outside of the microcomputer 20, and is connected to the microcomputer 20. The power supply IC 30 includes a watchdog timer (WDT) 32, an abnormality detecting part 34 configured to detect an abnormality in the microcomputer 20, and a reset part (RST) 36 configured to output a reset signal which causes the microcomputer 20 to be reset when the abnormality in the microcomputer 20 is detected by the abnormality detecting part 34. The abnormality detecting part 34 may determine whether there is the abnormality in the microcomputer 20 based on the monitoring result by the WDT 32 which monitors the WDC sent from the microcomputer 20. For example, the abnormality detecting part 34 causes the microcomputer 20 to be reset via the reset part 36 if there is no reversed WDC within a certain time period, there is an abnormality in the reverse frequency (i.e., the pulse width) of the WDC, or the like. It is noted that the reset part 36 may forcefully terminate the microcomputer 20 by the disconnection from the power supply, or may turn the power on again after the disconnection from the power supply.

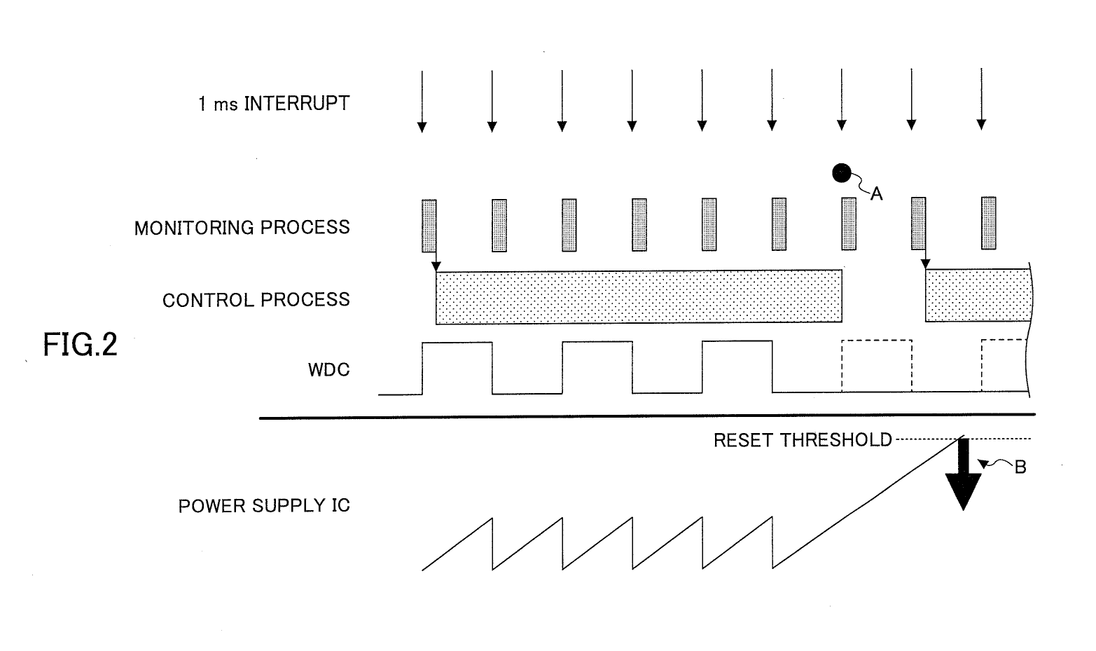

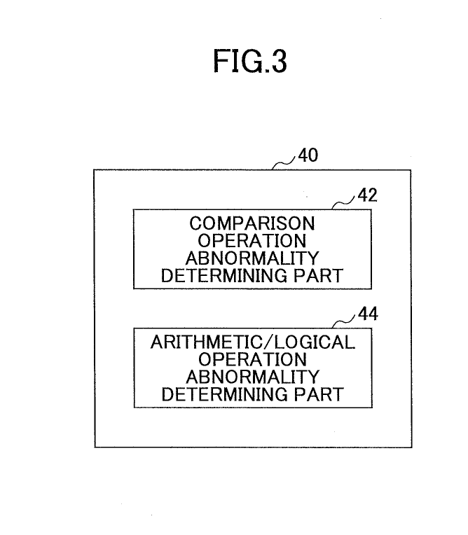

FIG. 2 is a timing chart of an example of an abnormality detecting process of the electronic arithmetic unit 10. A monitoring process of the microcomputer 20 is executed at the occurrence of an interrupt, for example, as illustrated in FIG. 2. The interrupt occurs every 1 ms, for example. The interrupt (pulse) is output by the highest priority process in the microcomputer 20. In the monitoring process, mainly, the operation results, etc., of the ALU 22, the PSU 24 and the BSF 26 are monitored and determined whether there is an error in them. The detail of the content of the monitoring process is described hereinafter with reference to FIGS. 3 through 6. It is noted that the control process may be executed independently from the monitoring process. The control process may be related to the vehicle control (the control of the hybrid system, for example), for example. In the illustrated example, the control process is executed every 8 ms. The watchdog cancel signal (WDC) is reversed when the monitoring result indicates that there is no abnormality. Thus, the WDC may be reversed every 1 ms under the normal condition. On the other hand, when the monitoring result indicates that there is an abnormality, the WDC is caused to be stopped. For example, as illustrated in FIG. 2, the WDC is stopped at the point A where there is an abnormality in the operation result, for example, and also stopped if there is no occurrence of the interrupt which otherwise would occur every 1 ms. As a result of this, the voltage exceeds a reset threshold in power supply IC 30 (see the arrow B in FIG. 2), which causes the microcomputer 20 to be reset. It is noted that the monitoring and determining operations in the monitoring process with respect to the abnormality in the operation results, etc., of the ALU 22, the PSU 24 and the BSF 26 may be performed at a cycle which is an integer multiple of the interrupt cycle of 1 ms, such as every 4 ms, for example. In this case, at the cycles other than the cycle corresponding to the integer multiple of the interrupt cycle of 1 ms, the WDC is reversed at the occurrence of the interrupt of every 1 ms, and at the cycle corresponding to the integer multiple of the interrupt cycle of 1 ms, the WDC is reversed according to the result of the monitoring and determining operations in the monitoring process with respect to the abnormality in the operation results, etc., of the ALU 22, the PSU 24 and the BSF 26.

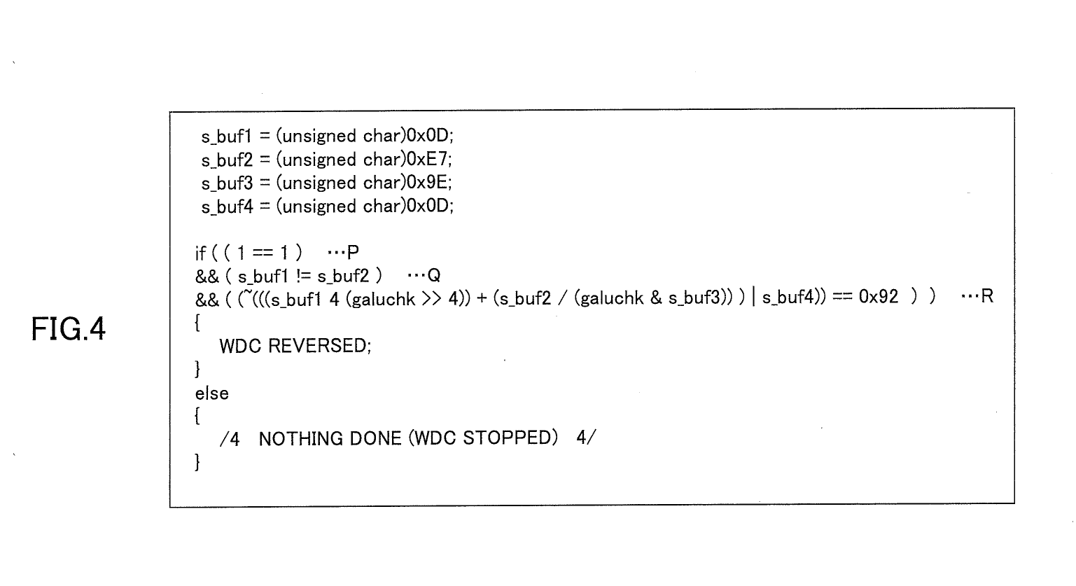

FIG. 3 is a diagram for illustrating a main function related to the monitoring process of a computing unit abnormality determining apparatus 40 according to one embodiment of the present invention. The computing unit abnormality determining apparatus 40 includes a comparison operation abnormality determining part 42 and an arithmetic/logical operation abnormality determining part 44, as illustrated in FIG. 3. The comparison operation abnormality determining part 42 and the arithmetic/logical operation abnormality determining part 44 may be implemented by the CPU 21 of the microcomputer 20 executing a monitoring process program (see FIG. 4) stored in the memory (not illustrated) such as ROM of the microcomputer 20.

FIG. 4 is a diagram for illustrating an example of a monitoring process program. It is noted that the program illustrated in FIG. 4 is described with the C language; however, as a matter of a fact, the program may described with other languages including high-level languages such as JAVA (registered trademark).

The monitoring process program illustrated in FIG. 4 includes, as main features, checking parts P and Q for the comparison operations and a checking part R for the arithmetic/logical operation.

The checking parts P and Q for the comparison operations are configured to check the comparison operations based on a comparison operator (==) at the assembler-expanded level. Specifically, the comparison operator (==) is assembler-expanded into two instructions of cmp and bne*, if it is assembler-expanded, and thus the checking is performed on an instruction basis. It is noted that a comparison operator (!=) is assembler-expanded into two instructions of “cmp” and “be*”, if it is assembler-expanded. “cmp” takes a differential between two values, and if the differential is 0 (i.e., match), a zero flag (ZF) is set (ZF=1). “bne” causes the program to branch to the outside of the “if statement” when ZF is equal to 0. “be” causes the program to branch to the outside of the “if statement” when ZF is equal to 1.

Specifically, in the checking part P, the comparison operation based on the comparison operator (==) between the same values is executed. In the illustrated example, in the checking part P, the process is performed such that a differential between “1” and “1” is taken, and if the differential is 0, the zero flag is set (ZF=1), and if ZF is equal to 0, the program is branched to the outside of the “if statement”. If there is no abnormality related to the comparison operation based on the comparison operator (==), when a differential between “1” and “1” is taken, the differential is 0, which causes the zero flag to be set. Then, since ZF is equal to 1, the program is not branched to the outside of the “if statement”.

With respect to the checking part P, branching to the outside of the “if statement” means that there is an abnormality in the comparison operation between the same values based on the comparison operator (==). Therefore, in this case, the WDC is stopped.

In the checking part Q, the comparison operation based on comparison operator (!=) between different values is executed. In the illustrated example, in the checking part Q, the process is performed such that a differential between “s_buf1” and “s_buf2” (both are ROM values) is taken, and if the differential is 0, the zero flag is set (ZF=1), and if ZF is equal to 1, the program is branched to the outside of the “if statement”. If there is no abnormality related to the comparison operation based on the comparison operator (!=), when a differential between “s_buf1” and “s_buf2” is taken, the differential is not 0, which causes the zero flag not to be set. Then, since ZF is equal to 0, the program is not branched to the outside of the “if statement”.

With respect to the checking part Q, branching to the outside of the “if statement” means that there is an abnormality in the comparison operation between the different values based on the comparison operator (!=). Therefore, in this case, the WDC is stopped.

For example, if the circuit portion related to “cmp” is abnormal and an abnormality occurs such that 0 is always output, in the checking part P, the zero flag is set and thus ZF is equal to 1. Thus, the program is not branched to the outside of the “if statement”. On the other hand, in the checking part Q, the zero flag is set and thus ZF is equal to 1. Thus, the program is branched to the outside of the “if statement”. In this way, by providing the checking part Q in addition to the checking part P, the comparison operation based on the comparison operator (==) can be checked accurately at the assembler-expanded level, thereby enabling determining whether there is an abnormality in the comparison operation with high reliability.

In the checking part R for the arithmetic/logical operation, comparison operation is performed to compare an operation result of a predetermined operational expression with the stored value of the corresponding correct value to determine whether there is an abnormality in the arithmetic/logical operation. In this example, the following operational expression is used as a preferred embodiment.

˜(((0x0D×(0x6A>>4))+(0xE7÷(0x6A&0x9E)))|0x0D)==0x92 (1)

It is noted that with respect to the relationship between FIG. 4 and the operational expression (1), “galuchk” in the checking part R corresponds to “0x6A”.

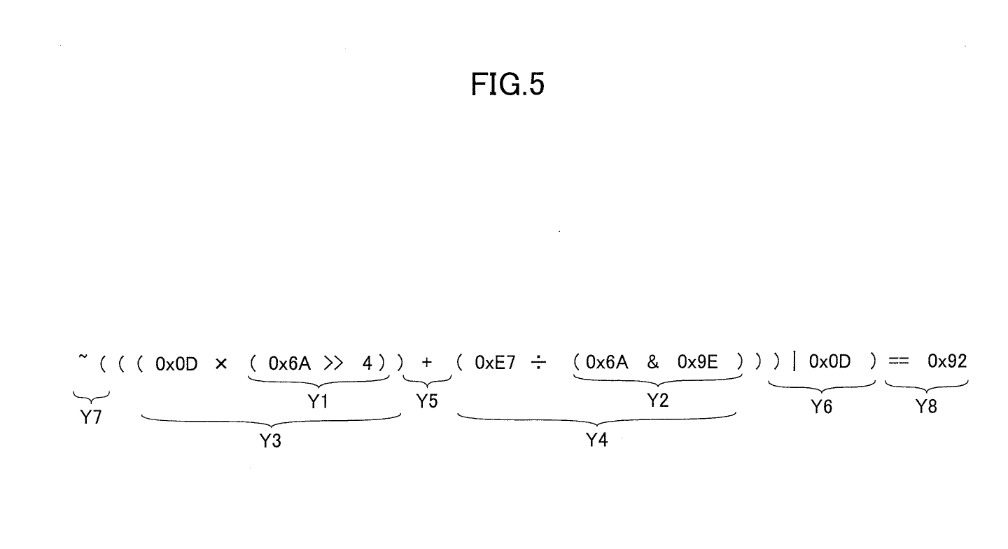

It is preferred that the predetermined operational expression includes all types of arithmetic operations and all types of logical operations. With this arrangement, it becomes possible to check whether there is an abnormality in various operations without omission. With respect to the operational expression (1), as illustrated in FIG. 5, the shifting operation is incorporated in the Y1 portion, the logical operation of “AND” is incorporated in the Y2 portion, the multiplication of the four basic arithmetic operations is incorporated in the Y3 portion, the division of the four basic arithmetic operations is incorporated in the Y4 portion, the addition of the four basic arithmetic operations is incorporated in the Y5 portion, the logical operation of “OR” is incorporated in the Y6 portion, the logical operation of “NOT” is incorporated in the Y7 portion, and the subtraction of the four basic arithmetic operations is incorporated in the Y8 portion. Further, it is preferred that the numerical values (“0x6A” and “0x9E”) in the logical operation of “AND” (Y2 portion) are selected such that all the 0 & 0, 0 & 1, 1 & 0 and 1 & 1 are included. Further, it is preferred that the numerical values (the resultant numerical value of the Y3 portion and the resultant numerical value of the Y4 portion) in the addition of the four basic arithmetic operations (Y5 portion) are set such that four patterns of the additions by four combinations of 0 and 1 are covered, and more preferably eight patterns of the additions with the carry and without the carry are covered. Further, it is preferred that the numerical values (the resultant numerical value obtained by the addition of the Y3 portion and the Y4 portion, and “0x0OD”) in the logical operation of “OR” (Y6 portion) are selected such that all the 0|0, 0|1, 1,|0 and |1| are covered. With this arrangement, it becomes possible to check all the patterns of various operations without omission.

With respect to the checking part R, if the operation result of the predetermined operational expression does not correspond to the stored value of the corresponding correct value, the zero flag is not set and thus ZF is equal to 0, which causes the program to branch to the outside of the “if statement”. Branching to the outside of the “if statement” means that there is an abnormality in the operation of the predetermined operational expression. Therefore, in this case, the WDC is stopped.

In this way, according to the monitoring process illustrated in FIG. 4, the checking results of three checking portions P, Q and R are combined with “AND” condition as a condition (WDC outputting condition) to be met to reverse the WDC. Thus, only if it is determined that there is no abnormality in all of these three checking portions P, Q and R, the WDC is reversed. In other words, if it is determined that there is an abnormality in any one of these three checking portions P, Q and R, the WDC is stopped, which causes the microcomputer 20 to be reset.

By the way, if there is no abnormality in the operation in the left side of the operational expression (1), the zero flag is set in the checking part R and thus ZF is equal to 1. Therefore, the program is not branched to the outside of the “if statement”. However, for example, if the circuit portion related to “cmp” is abnormal such that 0 is always output (i.e., different values are determined to be the same values due to an abnormality), the zero flag is set in the checking part R and thus the ZF is equal to 1, even if there is an abnormality in the operation in the left side of the operational expression (1). Therefore, in this case, in the checking part R, the program is not branched to the outside of the “if statement”, even if there is an abnormality in the operation in the left side of the operational expression (1). However, according to the monitoring process illustrated in FIG. 4, in such a case, since the zero flag is set and thus the ZF is equal to 1 in the checking part Q, the program is branched to the outside of the “if statement”. With this arrangement, it becomes possible to prevent the problem that the microcomputer 20 cannot be reset in spite of the fact that there is an abnormality in the left side of the operational expression (1) because of the incapability to detect the abnormality. In this way, by adding the condition “the different values are compared and it is determined that these values are not the same” to the WDC outputting condition, it becomes possible to effectively prevent the abnormality in the arithmetic/logical operation being hidden due to the abnormality in the comparison operation.

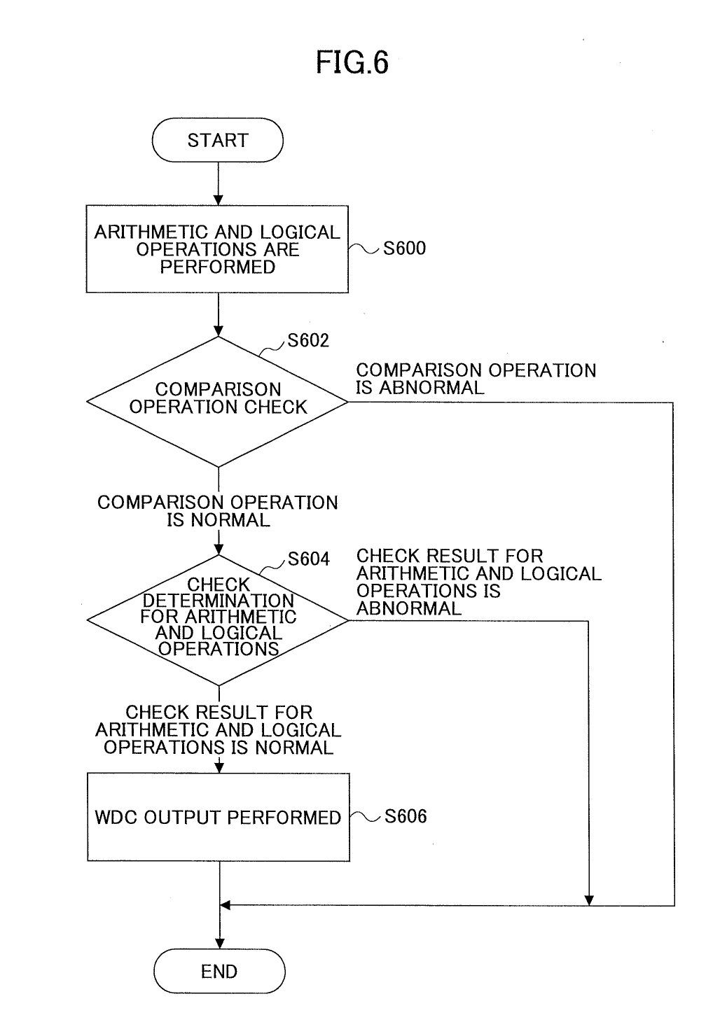

FIG. 6 is an example of a flowchart of a monitoring process executed by the computing unit abnormality determining apparatus 40.

In step 600, in the arithmetic/logical operation abnormality determining part 44, the arithmetic/logical operations of the predetermined operational expression are performed. Specifically, the operations of the left side of the operational expression (1) described above are performed. It is noted that the predetermined operational expression is stored in advance in the ROM or the like together with the corresponding answer value. There may be plural predetermined operational expressions prepared. In this case, the predetermined operational expression may be read one by one to be used in a predetermined order.

In step 602, it is checked in the comparison operation abnormality determining part 42 whether the comparison operation is normally performed. This checking process may be executed according to the method described above (see the checking parts P and Q for the comparison operation in FIG. 4). Specifically, the comparison operation between the same values and the comparison operation between the different values are performed, and it is determined that there is an abnormality in the comparison operation if there in an abnormality in any one of the comparison operations. If the comparison operation is normal, the monitoring process goes to step 604. On the other hand, if there is an abnormality in the comparison operation, the monitoring process ends without performing any particular process. In this case, the WDC is stopped and thus the microcomputer 20 is reset.

In step 604, in the arithmetic/logical operation abnormality determining part 44, the operation result of the arithmetic/logical operations performed in step 600 is compared with the stored value (i.e., the ROM value) of the corresponding answer value (the right side of the operational expression (1) to check whether the arithmetic/logical operations are normally performed in step 600 (see the checking part R for the arithmetic/logical operation in FIG. 4). If the operation result of the arithmetic/logical operations performed in step 600 corresponds to the corresponding answer value, it is determined that the arithmetic/logical operations are normally performed, and the monitoring process goes to step 606. On the other hand, if the operation result of the arithmetic/logical operations performed in step 600 does not correspond to the corresponding answer value, it is determined that there is an abnormality in the arithmetic/logical operations, and the monitoring process ends without performing any particular process. In this case, the WDC is stopped and thus the microcomputer 20 is reset.

In step 606, the WDC is output (reversed). Thus, the microcomputer 20 is not reset.

According to the computing unit abnormality determining apparatus 40 of this embodiment, the following effect among others can be obtained.

According to the computing unit abnormality determining apparatus 40 of this embodiment, as described above, since whether there is an abnormality in the comparison operation is checked at the assembler-expanded level, it is possible to determine whether there is an abnormality in the comparison operation with high reliability. Therefore, the abnormality determination of the arithmetic/logical operation involving the comparison operation can be performed with high accuracy. Further, since it becomes possible for the single microcomputer 20 to determine whether there is an abnormality in itself with high accuracy, a reliable monitoring function can be implemented with a reduced cost by the single microcomputer 20 and the single power supply IC 30. In other words, according to the computing unit abnormality determining apparatus 40 of this embodiment, it becomes possible to reduce the cost while keeping the reliability in comparison with a system in which plural microcomputers monitor each other.

The present invention is disclosed with reference to the preferred embodiments. However, it should be understood that the present invention is not limited to the above-described embodiments, and variations and modifications may be made without departing from the scope of the present invention.

For example, in the embodiments described above, it is possible to additionally check other operations. For example, in the embodiments described above, whether there is an abnormality in the floating-point operation; however, it is possible to perform the checking by incorporating the floating-point operation in the operational expression (1).

Further, in the embodiments described above, as preferable embodiments, the ALU check condition (see FIG. 6) is included in the WDC outputting condition to implement the monitoring of the ALU 22, etc., in parallel with the WDC monitoring. Such a configuration has an advantage in that the monitoring system can be implemented with low cost because the hardware resources are effectively utilized. However, the pulse width of the WDC may be varied according to the ALU check results (see step 602 and 604 in FIG. 6) to monitor the ALU 22, etc. However, in this case, an additional monitoring microcomputer for the ALU check becomes necessary, and high-performance monitoring IC becomes necessary. Further, a dedicated pulse separate from the WDC output may be output only when the ALU check results are normal (see YES in step 604 in FIG. 6). However, in this case, a separate connection line for monitoring the dedicated pulse becomes necessary between the microcomputer 20 and the power supply IC 30.

1. A computing unit abnormality determining apparatus which determines whether there is an abnormality in a computing unit, comprising:
a comparison operation abnormality determining part configured to perform a comparison operation using the computing unit to determine whether there is an abnormality in the comparison operation; and
an arithmetic/logical operation abnormality determining part configured to perform an arithmetic/logical operation of a predetermined operational expression using the computing unit, the predetermined operational expression including at least one of an arithmetic operation and a logical operation, and compare an operational result obtained by the arithmetic/logical operation with a corresponding stored value of a correct value to determine whether there is an abnormality in the arithmetic/logical operation.

2. The computing unit abnormality determining apparatus of claim 1, wherein the comparison operation abnormality determining part determines whether there is an abnormality in the comparison operation at a level where a comparison operator is expanded into a assembler code.

3. The computing unit abnormality determining apparatus of claim 1, wherein the comparison operation abnormality determining part performs the comparison operation between the same values and the comparison operation between the different values, and determines that there is an abnormality in the comparison operation if there in an abnormality in any one of the comparison operations.

4. The computing unit abnormality determining apparatus of claim 1, wherein the arithmetic/logical operation abnormality determining part performs the determination if it is determined by the comparison operation abnormality determining part that there is no abnormality in the comparison operation.

5. The computing unit abnormality determining apparatus of claim 1, wherein the computing unit abnormality determining apparatus is implemented by a computer which includes the computing unit.

6. The computing unit abnormality determining apparatus of claim 5, wherein the computer is configured to be reset by an external circuit if it is determined by the comparison operation abnormality determining part or the arithmetic/logical operation abnormality determining part that there is the abnormality.

7. The computing unit abnormality determining apparatus of claim 6, wherein the external circuit is a power supply IC of the computer.

8. A computing unit abnormality determining method of determining whether there is an abnormality in a computing unit, comprising:
performing a comparison operation using the computing unit to determine whether there is an abnormality in the comparison operation; and
performing an arithmetic/logical operation of a predetermined operational expression using the computing unit, the predetermined operational expression including at least one of an arithmetic operation and a logical operation, and comparing an operational result obtained by the arithmetic/logical operation with a corresponding stored value of a correct value to determine whether there is an abnormality in the arithmetic/logical operation.
